(19) United States
(12) Patent Application Publication
(10) Pub. No.: US 2024/0097515 A1
(43) Pub. Date: Mar. 21, 2024

(54) SEGMENTED GENERATOR, ROTOR SEGMENT, GENERATOR SEGMENT AND WIND TURBINE

(71) Applicant: Wobben Properties GmbH, Aurich (DE)

(72) Inventors: Manuel Feith, Esens (DE); Wojciech Giengiel, Aurich (DE); Stephan Jöckel, Kleinniedesheim (DE); Andreas Sattler, Emden (DE); Lars Fischer, Norden (DE); Alexander Philipp, Reilingen (DE)

(21) Appl. No.: 18/257,842

(22) PCT Filed: Dec. 17, 2021
(86) PCT No.: PCT/EP2021/086448

§ 371 Date: Jun. 15, 2023

(30) Foreign Application Priority Data
Dec. 18, 2020 (EP) 20215468.8

(51) Int. Cl. H02K 1/28; F03D 9/25; H02K 7/18; H02K 21/22

(52) U.S. Cl. CPC H02K 1/28; F03D 9/25; H02K 7/1838; H02K 21/22; F05D 2220/76

(57) ABSTRACT

A rotor segment of a segmented generator, in particular of a permanently excited segmented rotary generator, of a wind turbine, comprises a magnet carrier segment with a rotor circumferential face, in particular a rotor external circumferential face, which in a circumferential direction extends between a first and second separation interface by way of a segment length; the rotor circumferential face having a first separation interface portion having a first length proceeding from the first separation interface in the circumferential direction toward the second separation interface; and a second separation interface portion having a second length proceeding from the second separation interface in the circumferential direction toward the first separation interface; and a connection portion having a third length extending between the first and second separation interface; wherein in each case a reinforcement device for reinforcing the magnet carrier segment is disposed on the rotor circumferential face in the region of the first and second separation interface portion.

### BACKGROUND

### Technical Field

The disclosure relates to a segmented generator for a wind turbine. The disclosure furthermore relates to a rotor segment and to a generator segment of a segmented generator of a wind turbine. Furthermore, the disclosure relates to a wind turbine.

### Description of the Related Art

A wind turbine is a system that converts kinetic energy from wind into electric energy and feeds it into a power grid. For the conversion of the kinetic energy into electric energy, the wind turbine comprises a generator with a rotor, which is mounted so as to be rotatable about a rotation axis relative to a stator. Depending on the position of the rotation axis, a distinction is made between a horizontal and a vertical wind turbine. In the case of the horizontal wind turbine, the rotation axis is aligned horizontally. In the case of the vertical wind turbine, the rotation axis is aligned vertically. Horizontal wind turbines are also known as horizontal-axis wind turbines, and vertical wind turbines are also known as vertical-axis wind turbines.

Modern wind turbines generally concern so-called horizontal-axis wind turbines, in the case of which the rotation axis is disposed substantially horizontally and the rotor blades sweep through a substantially vertical rotor area. Furthermore, wind turbines have a nacelle which is disposed on a tower of the wind turbine so that it can rotate about a substantially vertical axis.

When the wind turbine is in an operating state, the wind causes rotation of the rotor blades which drive the rotor of a generator which is coupled to the rotor blades. In the operating state, the rotor blades and the rotor rotate relative to a stator of the generator. Due to the relative movement between rotor and stator, the (electric) generator generates electric energy. In the operating state of the wind turbine, the wind turbine is constructed at the installation site and is operated to convert the kinetic energy of the wind into electric energy.

Wind turbines can be configured without a gear or with a gear. In particular, gearless wind turbines have generators with a large diameter. It is quite common for the generators to have a diameter of 5 m and more. These generators can be configured as so-called internal rotors or as so-called external rotors. In the case of an internal rotor, the rotor of the generator rotating with the rotor blades is disposed inside a fixed stator of the generator. In the case of an external rotor, the rotor is disposed outside the stator. In the case of the external rotor, the stator is in particular disposed inside the rotor, preferably radially on the inside in relation to the rotor. Irrespective of the type of the generator, generators are usually fastened to the nacelle, in particular a machine carrier, of the wind turbine.

Generators can reach a mass of 150 t and more. The transport of such generators is therefore always associated with great complexity. Depending on the size of the diameter and the mass of the generator, road transport may also be simply impossible. In order to also be able to transport generators with a large diameter and a large mass, it is known to configure generators as segmented generators. Such a segmented generator has two or a plurality of generator segments. The generator segments are usually configured in a part-annular manner or have a part-annular geometry. The generator segments are generally disposed to form an annular segmented generator. Generator segments are usually transported individually to the installation site of a wind turbine.

The transport of generator segments of a segmented generator with electromagnets is easily possible without great complexity. If these generator segments are de-energized, no magnetic forces are effective. On the other hand, if such a segmented generator has permanent magnets, additional fastening devices must be provided which hold a rotor segment in a desired position relative to a stator segment and counteract the magnetic forces of the permanent magnets. Such fastening devices, which hold a rotor segment in relation to a stator segment, are known, for example, from EP 2 508 749 B1 and EP 2 454 803 B1.

The assembly of these components, which are unwieldy despite segmentation, is associated with challenges. The resulting deformation, particularly in the region of separation interfaces of the generator segments, makes it difficult to join and assemble generator segments to form a segmented generator of a wind turbine.

The European Patent Office has searched the following prior art in the priority application for the present application: CN 112 018 968 A, AU 2018 431 391 A1, CN 108 964 301 A, EP 3 637 587 A1.

### BRIEF SUMMARY

Provided is a segmented generator for a wind turbine, a rotor segment of a generator segment, a generator segment of the segmented generator and a wind turbine that eliminate or reduce one or a plurality of the disadvantages mentioned. Provided is one or more technique that improves the ease of assembling the segmented generator for a wind turbine, the rotor segment of a generator segment, the generator segment and the wind turbine.

Unless expressly stated otherwise, information on the axial direction, the circumferential direction and the radial direction in the description is to be understood in terms of the rotation axis of the generator. The axial direction corresponds to a direction parallel to, i.e., along, the rotation axis. The circumferential direction corresponds to a direction substantially tangential to the rotation axis. The radial direction corresponds to a direction radial to the rotation axis.

The segmented generator for a wind turbine comprises two or a plurality of generator segments. The two or plurality of generator segments are preferably disposed in an annular manner. In particular, the two or plurality of generator segments are disposed coaxially with a rotation axis of the segmented generator. In particular, the segmented generator comprises a segmented rotor and a segmented stator. The segmented rotor comprises two or a plurality of rotor segments. The segmented stator comprises two or a plurality of stator segments.

The respective generator segment or the respective rotor segment and/or the respective stator segment in a circumferential direction are preferably configured in a part-annular manner in terms of the rotation axis. In particular, the generator segment or the rotor segment and/or the stator segment have a part-annular geometry. A generator segment or a rotor segment and/or a stator segment, which is correspondingly configured in a part-annular manner or has a part-annular geometry, extends in the circumferential direction with a specific degree of arc between a first and second separation interface.

The two or plurality of generator segments or the two or plurality of rotor segments and/or two or plurality of stator segments preferably extend with the same degree of arc in the circumferential direction. In particular, the generator segments or the rotor and/or stator segments extend as a function of the following formula, depending on the number of the respective segments: 360°/(number of segments). According to this, for example, the generator segments of a segmented generator, which comprises two generator segments, each extend in the circumferential direction by 180°; with three generator segments it would be 120°, with four generator segments it would be 90° etc. This can apply in an analogous manner to the rotor segments and/or stator segments.

It can also be preferred that the generator segments from which a segmented generator is assembled extend in the circumferential direction with a different degree of arc. For example, a segmented generator can be formed from three generator segments. In such a segmented generator, for example, a first generator segment can extend in the circumferential direction by 180°, a second generator segment by 120° and a third generator segment by 60°. Any other extents in the circumferential direction of the generator segments are conceivable, provided that when assembled they result in an extent of 360° in the circumferential direction. The explanations pertaining to the generator segment can apply in an analogous manner to a rotor segment of a segmented rotor and/or a stator segment of a segmented stator.

The first and second separation interface extend substantially orthogonally to the circumferential direction. In particular, the first and second separation interface define a first and second separation interface plane within which the rotation axis extends. In particular, the first and/or second separation interface extend in such a manner that the first and/or second separation interface plane extend in a radial direction in terms of the rotation axis. In particular, the first and/or second separation interface plane, which extend in the radial direction in terms of the rotation axis, intersect in an axis that is or defines the rotation axis. In particular, the rotation axis lies in the first and/or second separation interface plane, which extend in the radial direction in terms of the rotation axis.

The first and/or second separation interface of a generator segment has a connection device. The connection device at the first and/or second separation interface is configured to connect to one another adjacent generator segments that are disposed to form a segmented generator. The connection device of the first and/or second separation interface is configured in particular to mechanically connect adjacent generator segments. The mechanical connection can be configured as a force-fitting and/or materially integral and/or form-fitting connection. The first and/or second separation interface preferably have a flange connection and/or a threaded connection as a connection device for fastening adjacent generator segments in the circumferential direction. The explanations pertaining to the generator segment can apply in an analogous manner to a rotor segment of a segmented rotor and/or a stator segment of a segmented stator.

In addition or as an alternative, it is also preferred that the segmented generator is configured as a permanently excited segmented generator. In this preferred embodiment, it is provided that one or a plurality of permanent magnets are disposed on the rotor. A permanent magnet, also known as a permanently excited magnet, is a magnet that has a constant magnetic field that is not generated by electric power, as is the case with electromagnets. The permanent magnet is composed of a magnetized material. Examples of magnetized materials of a permanent magnet are alloys of iron, cobalt, nickel, etc.

The segmented generator is preferably configured as an external rotor. In the case of a segmented generator configured as an external rotor, the stator or segmented stator in relation to the rotor or segmented rotor in the radial direction is located on the inside in terms of the rotation axis. In the case of a segmented generator configured as an external rotor, its segmented rotor lying radially on the outside usually encloses the segmented stator lying radially on the inside.

With the segmented design of the generator, transport-related size restrictions of a generator can be overcome. In particular, by transporting the generator segments individually, segmented generators can also be transported to installation sites of wind turbines that are difficult to access and be assembled on the tower of the wind turbines on the nacelle. In particular, no large and expensive special cranes are required for the assembly of a segmented generator. Rather, the generator segments can be positioned individually on the nacelle or the machine carrier with a small crane, which only has to carry the mass of a single generator segment and reach the assembly height. This saves costs that would otherwise be incurred for the much more expensive large cranes. Furthermore, such large cranes are generally only available to a limited extent, and so the segmented generator offers more flexibility with regard to the assembly time and also the assembly location.

In particular, the generator according to the disclosure is configured to assume a reinforcing effect for the nacelle as soon as the generator is assembled on the nacelle. For this purpose, it is preferably provided that a flange of the nacelle, to which the generator is fastened, is configured to be comparatively small, and the flange for mounting the generator on the nacelle is configured to be comparatively large. This advantageously reduces the weight of the nacelle without negatively influencing the stiffness of the wind turbine when the generator is in the state assembled on the nacelle. In particular, this has the advantage that the nacelle can be installed more easily, quickly and cost-effectively using conventional and therefore readily available cranes.

In terms of further advantages, design variants and design details of the segmented generator according to the disclosure and its refinements, reference is also made to the following description of the corresponding features and refinements of the rotor segment, the generator segment and the wind turbine.

Provided is a rotor segment of a segmented generator for a wind turbine. It is to be understood that the rotor segment is a rotor segment for a rotor, in particular for a segmented rotor. Furthermore, it is to be understood that the rotor is a rotor for a generator, in particular for a segmented generator.

The rotor segment of the segmented generator comprises a magnet carrier segment with a rotor circumferential face. The rotor circumferential face is in particular a rotor external circumferential face. The magnet carrier segment by way of a segment length extends in a circumferential direction between a first and second separation interface. The rotor circumferential face has a first separation interface portion, a second separation interface portion, and a connection portion. The first separation interface portion by way of a first length extends proceeding from the first separation interface in the circumferential direction toward the second separation interface. The second separation interface portion by way of a second length extends proceeding from the second separation interface in the circumferential direction toward the first separation interface. The connection portion by way of a third length extends between the first and second separation interface. In each case a reinforcement device for reinforcing the magnet carrier segment is disposed on the rotor circumferential face in the region of the first and second separation interface portion.

The rotor segment preferably extends in the radial direction between a radially inner flange for fastening the rotor segment to the rotor base body flange of a bearing unit and the radially outer magnet carrier segment. The rotor segment by way of a rotor support section preferably extends between the radially inner flange for fastening the rotor segment to the rotor base body flange of the bearing unit and the radially outer magnet carrier segment. It is to be understood that the rotor segment can be configured in multiple parts or integrally. In particular, it is to be understood that the rotor segment can be configured integrally from individual rotor segments welded to one another. The rotor segment has in particular the magnet carrier segment with an annular or part-annular geometry, at least one laminated rotor core and a rotor internal circumferential face. In particular, the at least one laminated rotor core is connected to the magnet carrier segment in a materially integral and/or force-fitting and/or form-fitting manner.

A plurality of magnet units are preferably disposed on the laminated rotor core at a spacing from one another in the circumferential direction and form and/or define the rotor internal circumferential face. In particular, two or a plurality of magnet units are disposed at a spacing from one another in the axial direction, wherein the magnet units disposed adjacently in the axial direction define a circumferential gap with a gap width for feeding and for distributing a cooling medium. The at least one magnet unit is in particular connected in a materially integral manner to the laminated rotor core. A casting compound, which at least partially encloses the magnet unit, preferably connects the magnet unit to the laminated rotor core.

The magnet units are also known as rotor active part.

The magnet carrier segment in the axial direction along the rotation axis has an extent by way of a magnet carrier segment width. The width of the magnet carrier segment is preferably constant over the circumference of the latter. In particular, in the axial direction, the first and second separation interface portion have a first and second width and the connection portion has a third width. Preferably, the first and second width are identical. The third width preferably corresponds to the first and/or second width. The third width is preferably smaller than the first and/or second width.

The magnet carrier segment in the radial direction orthogonal to the rotation axis preferably has an extent by way of a magnet carrier segment height. The height of the magnet carrier segment is preferably constant over the circumference of the latter. In particular, in the axial direction, the first and second separation interface portion have a first and second height and the connection portion has a third height. Preferably, the first and second height are identical. The third height preferably corresponds to the first and/or second height. The third height is preferably smaller than the first and/or second height.

The details pertaining to the first and/or second and/or third length and/or width and/or height are preferably to be understood in each case as details pertaining to a mean first and/or second and/or third length and/or width and/or height. In this respect, the first and/or second separation interface portion and/or the connection portion can each partially have a length and/or width and/or height that differ from the first and/or second and/or third length and/or width and/or height. It can also be preferred that the details pertaining to the first and/or second and/or third length and/or width and/or height are in each case details pertaining to a maximum first and/or second and/or third length and/or width and/or height.

The reinforcement device has a length in the circumferential direction, a width in the axial direction and a height in the radial direction. Preferably, the reinforcement device is longer than it is wide and/or wider than it is high.

In particular, the length of the reinforcement device corresponds to the first and/or second length of the respective separation interface portion. Alternatively, it may be preferred that the length of the reinforcement device differs from the first and/or second length of the respective separation interface portion. In particular, the length of the reinforcement device is shorter than the first and/or second length of the respective separation interface portion. It may also be preferred that the length of the reinforcement device is longer than the first and/or second length of the respective separation interface portion.

In particular, the width of the reinforcement device corresponds to the first and/or second width of the respective separation interface portion. Alternatively, it may be preferred that the width of the reinforcement device differs from the first and/or second width of the respective separation interface portion. In particular, the width of the reinforcement device is shorter than the first and/or second width of the respective separation interface portion. It may also be preferred that the width of the reinforcement device is wider than the first and/or second width of the respective separation interface portion.

In particular, it can be preferred that the reinforcement device protrudes in the circumferential direction beyond the first and/or second separation interface portion. It can be preferred that the reinforcement device protrudes beyond the first and/or second separation interface. In particular, it can be preferred that the reinforcement device protrudes beyond the first and/or second separation interface portion in the axial direction.

The respective reinforcement device is preferably mechanically connected to the magnet carrier segment. In particular, the respective reinforcement device is connected in a force-fitting and/or materially integral and/or form-fitting manner to the magnet carrier segment. In particular, the respective reinforcement device is mechanically connected to the rotor external circumferential face. The respective reinforcement device is preferably welded to the magnet carrier segment. It can also be preferred that the respective reinforcement device is screwed to the magnet carrier segment. Additionally or alternatively, in a preferred embodiment of the rotor segment, the respective reinforcement device can be connected in a form-fitting manner to the magnet carrier segment by correspondingly provided projections and recesses.

A reinforcement device disposed in the region of the first separation interface portion is preferably configured identically to a reinforcement device disposed in the region of the second separation interface portion.

The disposal of the reinforcement device according to the disclosure in the region of the first and/or second separation interface portion is to be understood in particular as an additional reinforcement. In particular, the disposal of the reinforcement device according to the disclosure in the region of the first and/or second separation interface portion is to be understood to mean a reinforcement which is absent in the connection portion. In particular, the rotor segment can have reinforcing arrangements which are present in the first and/or second separation interface portion as well as in the connection portion. In such a reinforcing arrangement, preferably no reinforcement device which is disposed in the region of the first and/or second separation interface portion can be seen. In particular, a reinforcing arrangement is configured differently from the reinforcement device according to the disclosure.

The reinforcement device disposed in the region of the first and/or second separation interface portion has the advantage that the rotor segment reinforces the rotor segment in these portions, in particular in the region of the first and/or second separation interface. The reinforcement device has in particular the effect that in the region of the first and/or second separation interface portion the air gap between a rotor segment and a stator segment of a generator segment of a segmented generator corresponds to an air gap between the rotor segment and the stator segment in the region of the connection portion. In particular, the air gap “set” for operation of the segmented generator can be maintained with the reinforcement device. In a particularly advantageous manner, the reinforcement device prevents the formation of dents in the region of the first and/or second separation interface portion, in particular when the generator segments of a segmented generator are stored or transported separately from one another and are not assembled as an annularly segmented generator.

Furthermore, the reinforcement device facilitates the assembling or joining of the generator segments to form a segmented generator, since the connection devices at the first and/or second separation interface of adjacent generator segments are co-aligned so as to be planar.

In terms of further advantages, design variants and design details of the rotor segment according to the disclosure and its refinements, reference is made to the previously given description of the corresponding features and refinements of the segmented generator.

According to a preferred embodiment of the rotor segment, the reinforcement device in the region of the first and/or second separation interface portion locally reinforces the magnet carrier segment in relation to the region of the magnet carrier segment in the connection portion.

According to a further preferred refinement of the rotor segment, the magnet carrier segment with the reinforcement device in the region of the first separation interface portion has a first stiffness, the magnet carrier segment with the reinforcement device in the region of the second separation interface portion has a second stiffness, and the connection portion has a third stiffness, wherein the third stiffness of the connection portion is less than the first and/or second stiffness of the first and/or second separation interface portion, and/or the third stiffness of the connection portion corresponds to the first and/or second stiffness of the first and/or second separation interface portion, and/or the third stiffness of the connection portion is greater than the first and/or second stiffness of the first and/or second separation interface portion.

It may be preferred that the first stiffness varies between a first minimum and maximum stiffness. Furthermore, it can be preferred that the second stiffness varies between a second minimum and maximum stiffness. It may also be preferred that the third stiffness varies between a third minimum and maximum stiffness. In particular, the first and/or second and/or third stiffness of the respective portion varies in the circumferential direction and/or the axial direction and/or the radial direction.

In particular, the first and/or second separation interface portion and/or the connection portion, the first and/or second and/or third stiffness of which varies, have a first and/or second and/or third mean stiffness. The respective mean stiffness lies between the respective minimum and maximum stiffness. In particular, the respective stiffness is an mean value of the stiffnesses of a respective portion. Furthermore, it can be preferred that the respective mean stiffness corresponds to the mean value of the respective minimum and maximum stiffness of a respective portion.

Preferably, the first and/or second stiffness in the region of the first and/or second separation interface portion is at least 105%, 110%, 120%, 130%, 140%, 150%, 200% or more. In particular, the first and/or second stiffness in the region of the first and/or second separation interface portion is at most 500%, 400%, 300%, 200%, 150%, 140%, 130%, 120%, 110% or 105%. Preferably, the first and/or second mean stiffness in the region of the first and/or second separation interface portion is at least 105%, 110%, 120%, 130%, 140%, 150%, 200% or more. In particular, the first and/or second mean stiffness in the region of the first and/or second separation interface portion is at most 500%, 400%, 300%, 200%, 150%, 140%, 130%, 120%, 110% or 105%.

In particular, the stiffness of the magnet carrier segment without the reinforcement device is lower in the region of the first and/or second separation interface portion than in the region of the connection portion.

The stiffness of the respective portions describes, in particular, the resistance of the respective portions to elastic deformation, for example dent formation, which can be caused by the disposal of permanent magnets. In particular, the stiffness of the respective portions should be selected such that the magnetic force between the rotor segment and stator segment acting due to the disposal of permanent magnets causes only a deformation of the rotor segment, in particular the magnet carrier segment, within specified tolerances.

The stiffness of the respective portions comprises an elongation stiffness and/or a shear stiffness and/or a flexural stiffness and/or a torsional stiffness. Descriptions generally pertaining to the stiffness, in particular to the first and/or second and/or third stiffness, preferably apply in an analogous manner to the elongation stiffness and/or the shear stiffness and/or the flexural stiffness and/or the torsional stiffness.

According to a further preferred embodiment of the rotor segment, the first separation interface portion and the second separation interface portion are of substantially identical configuration.

This has the advantage that the rotor segment can be manufactured particularly cost-effectively. In particular, the use of identical parts allows economies of scale to be achieved when procuring the identical parts. Furthermore, the substantially identical configuration of the first and/or second separation interface portion minimizes the susceptibility to errors in the manufacture of the rotor segment. Furthermore, a rotor segment configured in this way facilitates assembly at the installation site of the segmented generator.

In a further preferred embodiment of the rotor segment, the magnet carrier segment and the reinforcement device in the first and/or second separation interface portion form a cross section with a cross-sectional area and/or a cross-sectional shape that differs from a cross-sectional area and/or a cross-sectional shape of a cross section of the magnet carrier segment in the connection portion, wherein in particular the cross-sectional area of the first and/or second separation interface portion is larger than the cross-sectional area of the connection portion; and/or the cross section of the first and/or second separation interface portion has a moment of inertia of area and/or a moment of torsional inertia which is greater than a moment of inertia of area and/or a moment of torsional inertia of the cross section of the connection portion.

This has the effect that a higher first and/or second stiffness is obtained in the first and/or second separation interface portion. In particular, this has the effect that the first and/or second stiffness of the first and/or second separation interface portion is higher than the third stiffness of the connection portion.

According to a further preferred embodiment of the rotor segment, the reinforcement device comprises a material with a Young's modulus or is composed of the material with the Young's modulus greater than a Young's modulus of a material which the magnet carrier segment comprises or of which the magnet carrier segment is composed.

In particular, this has the advantage that material and, to that extent, weight can be saved. Furthermore, the saving in material preferably leads to a cost saving.

In a further preferred refinement of the rotor segment, the first and/or second length of the first and/or second separation interface portion corresponds to at least 10%, preferably at least 20%, and at most 50%, preferably at most 40%, of the segment length; and/or the magnet carrier segment along a rotation axis has a segment width and the reinforcement device has a width that corresponds to at least 30%, preferably at least 50%, and at most 80%, preferably at most 100%, of the segment width.

In a further preferred refinement of the rotor segment, the first and/or second height of the first and/or second separation interface portion corresponds to at least 110%, preferably at least 120%, preferably at least 150%, preferably at least 200%, and at most 500%, preferably at most 400%, preferably at most 300%, of the third height of the connection portion of the magnet carrier segment. The first and/or second height of the first and/or second separation interface portion preferably corresponds to a height of the magnet carrier segment and/or the height of the reinforcement device.

In particular, it can be preferred that the first and/or second width and/or height in the circumferential direction of the first and/or second separation interface portion, in particular of the magnet carrier segment and/or the reinforcement device in the region of the first and/or second separation interface portion, proceeding from the first and/or second separation interface, varies, preferably decreases, in the direction of the connection portion. In particular, it is preferred that the first and/or second width and/or height continuously decreases in the circumferential direction, preferably linearly and/or convexly and/or concavely. The first and/or second width and/or height of the first and/or second separation interface portion at the transition to the connection portion preferably corresponds to the third width and/or height of the connection portion. It can also be preferred that the height and/or width of the connection portion varies discontinuously, in particular in steps, toward the first and/or second separation interface portion.

In particular, a continuous transition from the first and/or second separation interface portion to the connection portion preferably minimizes the notch effect.

According to a further preferred embodiment of the rotor segment, the reinforcement device has a planar reinforcement element; and/or one or a plurality of axial webs, which have a main extent along the rotation axis; and/or one or a plurality of circumferential webs, which have a main extent in the circumferential direction orthogonal to the rotation axis; and/or one or a plurality of diagonal webs, which have a main extent diagonal to the circumferential direction and the rotation axis.

The planar reinforcement element preferably extends over the first and/or second length and/or width of the first and/or second separation interface portion.

The axial webs and/or circumferential webs and/or diagonal webs preferably have an I-shaped and/or U-shaped and/or Z-shaped and/or L-shaped cross-sectional profile. It can also be preferred that the axial webs and/or circumferential webs and/or diagonal webs form a hollow profile in cross section. In particular, the hollow profiles can be rectangular and/or square and/or tubular hollow profiles.

In particular, two planar reinforcement elements and two circumferential webs and/or two axial webs can also form a box-shaped profile.

It can be preferred that the axial webs of a reinforcement device with a plurality of axial webs have a different length and/or width and/or height. It can be preferred that the circumferential webs of a reinforcement device with a plurality of axial webs have a different length and/or width and/or height. It can be preferred that the diagonal webs of a reinforcement device with a plurality of axial webs have a different length and/or width and/or height.

In a further preferred embodiment of the rotor segment, a plurality of axial webs are disposed equidistantly from one another in the circumferential direction; and/or a plurality of circumferential webs are disposed equidistantly from one another in the axial direction; and/or the planar reinforcement element is disposed spaced parallel to the rotor circumferential face.

In a further preferred embodiment of the rotor segment, the reinforcement device is welded and/or screwed to the rotor circumferential face. In particular, the reinforcement device can be adhesively bonded to the rotor circumferential face.

In a further preferred refinement, the rotor segment comprises a reinforcement ring segment, which has a substantial main direction of extent in the circumferential direction and/or a radial direction, for reinforcing the rotor segment.

The reinforcement ring segment is also known as a reinforcing disk. The reinforcement ring segment is preferably disposed between the magnet carrier segment and the rotor base body flange of a bearing unit. In particular, the reinforcement ring segment is disposed at a spacing from the rotor support section in the axial direction. Usually, a stator segment is disposed between the rotor support section and the reinforcement ring segment in the axial direction.

In this preferred embodiment, the reinforcement ring segment prevents deformation of the rotor segment, in particular of the magnet carrier segment, in the radial direction. In this way, in particular, an air gap set for operation between the rotor segment and the stator segment of a generator segment of a segmented generator can be maintained in the circumferential direction. Furthermore, the higher stiffness of the rotor segment resulting from the reinforcement ring segment leads to improved ease of assembly of adjacent rotor segments to form an annular segmented rotor.

Some embodiments include a generator segment of a segmented generator for a wind turbine. It is to be understood that the generator segment is a generator segment for a segmented generator for a wind turbine.

Such a generator segment of a segmented generator of a wind turbine comprises, as also already described above, a rotor segment of a rotor. In particular, the rotor segment is a rotor segment according to the disclosure as described above and/or a preferred refinement of the rotor segment as described above.

In terms of advantages, design variants and design details of the generator segment according to the disclosure and its refinements, reference is made to the previously given description of the corresponding features and refinements of the segmented generator and the rotor segment.

In a preferred refinement, the generator segment comprises a stator segment of a stator. In particular, the stator segment is disposed radially on the inside of the rotor segment in terms of the rotation axis. In particular, the rotor segment encloses the stator segment. This advantageously leads to a more powerful generator.

Some embodiments include a wind turbine.

Such a wind turbine comprises a segmented generator according to the disclosure, in particular a segmented generator according to one of the previously described embodiments or a combination thereof.

In terms of advantages, design variants and design details of the wind turbine according to the disclosure and its refinements, reference is made to the previously given description of the corresponding features and refinements of the segmented generator and the generator segment and the rotor segment.

### BRIEF DESCRIPTION OF THE SEVERAL VIEWS OF THE DRAWINGS

Embodiments will be explained by way of example with the aid of the appended figures.

FIG. 1 shows a schematic, three-dimensional view of an exemplary embodiment of a wind turbine in an operating state.

FIG. 2 shows a schematic, three-dimensional view of an exemplary embodiment of a generator segment with a preferred embodiment of a reinforcement device.

FIG. 3 shows a schematic, three-dimensional view of an exemplary embodiment of a segmented generator with a further preferred embodiment of a reinforcement device.

FIG. 4 shows a schematic, two-dimensional view of a further exemplary embodiment of a generator segment.

FIGS. 5a, 5b, and 5c show a two-dimensional frontal, lateral and plan view from above of a connection portion of the generator segment illustrated in FIG. 4.

FIGS. 6a, 6b, and 6c show a two-dimensional frontal, lateral and plan view from above of a first and second separation interface portion of the generator segment illustrated in FIG. 4.

FIG. 7 shows a schematic, three-dimensional view of a further exemplary embodiment of a generator segment.

In the figures, identical or substantially functionally identical or similar elements are denoted by the same reference designations. If general reference is made to a generator, rotor or stator in the present description of the figures, this in principle includes a segmented generator, segmented rotor or segmented stator, unless this is expressly described otherwise.

### DETAILED DESCRIPTION

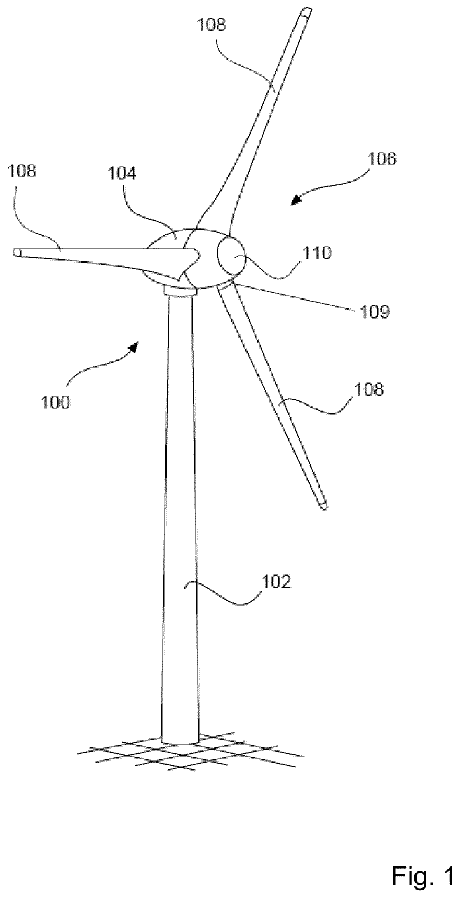

FIG. 1 shows a schematic, three-dimensional view of an exemplary embodiment of a wind turbine. FIG. 1 shows in particular a wind turbine 100 with a tower 102 and a nacelle 104. A rotor 106 having three rotor blades 108 and having a spinner 110 is disposed on the nacelle 104. During operation, the rotor 106 is set in rotation by the wind and thereby drives a generator in the nacelle 104. The tower 102 has, in particular, wind turbine steel tower ring segments with flange segments. As a result, the tower 102 is constructed using components that are easy to transport and that can also be connected with great precision and with little effort.

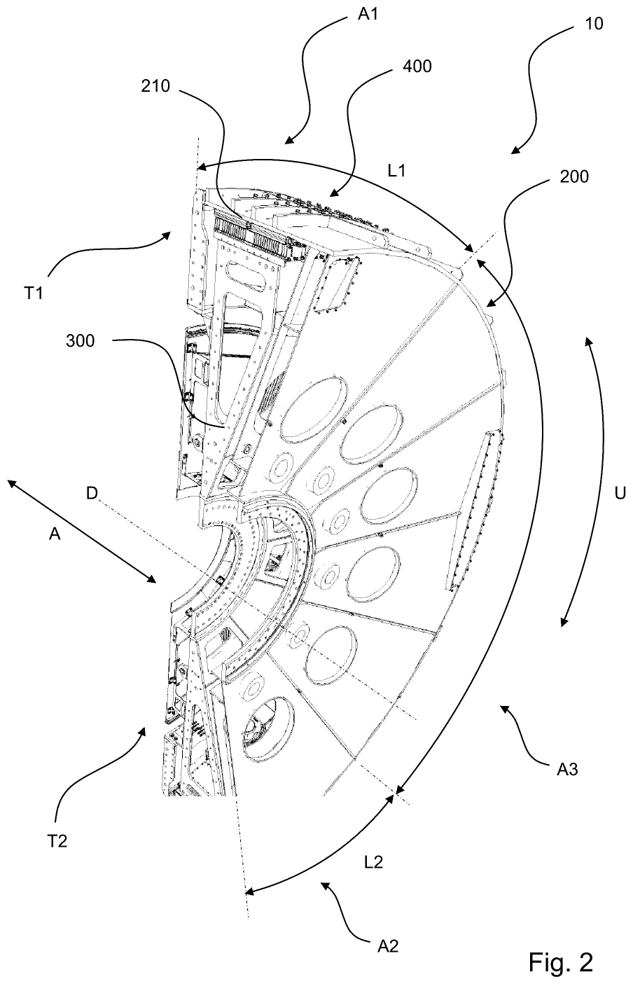

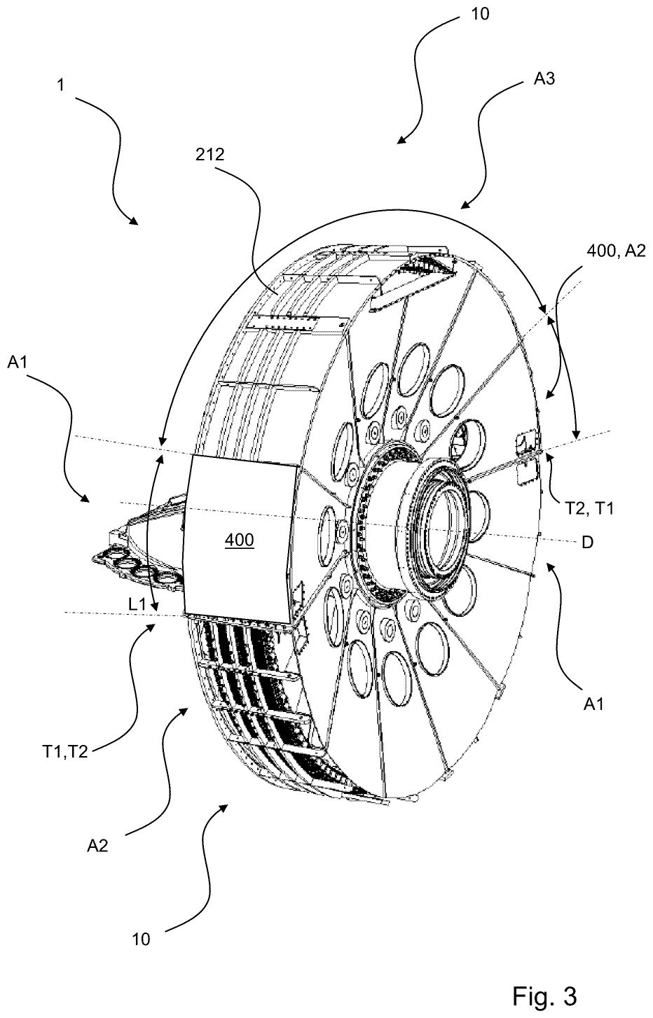

A schematic, three-dimensional view of a preferred embodiment of a generator segment 10 of a segmented generator 1 is shown in FIG. 2. Shown in FIG. 3 is a schematic, three-dimensional view of a preferred embodiment of a segmented generator 1 assembled from two generator segments 10. The generator segments 10 have a rotor segment 200 and a stator segment 300. The generator segments 10 shown in FIGS. 2 and 3 are configured for a segmented generator configured as an external rotor. In this respect, the stator segment 300 is disposed within the rotor segment 200.

The generator segments 10 or the rotor segments 200 and stator segments 300 extend in a circumferential direction U between a first separation interface T1 and a second separation interface T2. The first and second separation interface T1, T2 define a first and second separation interface plane, within which the rotation axis D extends.

The first and second separation interface T1, T2 of the generator segment 10 have a connection device which is configured to connect adjacent generator segments 10, which are disposed to form a segmented generator 1, to one another. In the preferred embodiment, the connection device of the first and second separation interface T1, T2 is configured to mechanically connect adjacent generator segments 10, i.e., adjacent rotor segments 200 and adjacent stator segments 300. For this purpose, the first and second separation interface T1, T2 have a flange connection and a threaded connection as a connection device. Derived from the generator segment 10 illustrated schematically in FIG. 2 is a connection device configured with flange connections at the first and second separation interface T1, T2. In the segmented generator 1 illustrated schematically in FIG. 3, the two generator segments 10 at the respective separation interfaces T1, T2 are connected to one another in the circumferential direction via the corresponding flange connections with threaded connections.

The rotor segments 200 illustrated in FIGS. 2 and 3 have a magnet carrier segment 210 with a rotor circumferential face 212. A reinforcement device 400 is disposed on the rotor circumferential face 212, in particular the rotor external circumferential face, in the region of the first and second separation interface portion A1, A2. The reinforcement devices 400 in FIG. 2 as well as in FIG. 3 extend in the first and second separation interface portion A1, A2 by way of a first and second length L1, L2. In particular, the reinforcement devices 400 extend by way of the same length in the first and second separation interface portion A1, A2. In particular, the reinforcement devices 400 disposed in the region of the first and second separation interface portion A1, A2 are of identical configuration. In the preferred embodiments of the generator segments 10 illustrated in FIGS. 2 and 3, the first and second length L1, L2 of the first and second separation interface portion A1, A2 corresponds to one sixth of the segment length of the rotor segment 200. The third length L3 of the connection portions A3 of these preferred embodiments of the generator segments 10 corresponds to four sixths of the segment length of the rotor segment 200.

The preferred embodiment of the reinforcement device 400 illustrated in FIG. 2 has three circumferential webs which are disposed parallel to one another and spaced apart in the axial direction A and which are fastened to the magnet carrier segment 210 by way of threaded connections. FIG. 3 shows the reinforcement device 400 in a further preferred embodiment as a reinforcement element which extends in a planar manner and is connected to the magnet carrier segment 210 by means of a welded connection. It can be seen both in FIG. 2 and in FIG. 3 that the reinforcement device 400 disposed in the region of the first separation interface portion A1 has a length in the circumferential direction U and a width in the axial direction A that corresponds to the first length and first width of the first separation interface portion A1.

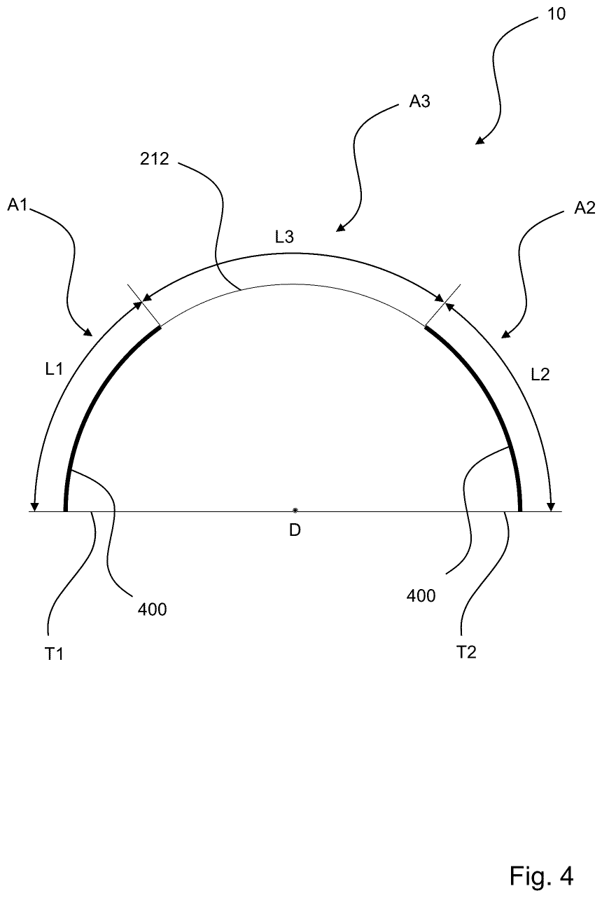

FIG. 4 shows a schematic, two-dimensional view of a further exemplary embodiment of a generator segment 10. In this preferred embodiment, the rotor segment 200 has a first and second separation interface portion A1, A2 between which a connection portion A3 extends. The first and second separation interface portion A1, A2, proceeding from a first and second separation interface T1, T2, extend in the direction of the connection portion A3. In this preferred embodiment, the first and second length L1, L2 of the first and second separation interface portion A1, A2 and the third length L3 of the connection portion A3 each correspond to one third of the segment length of the rotor segment 200. In this preferred embodiment, in the circumferential direction, the first and second separation interface portion A1, A2 and the connection portion A3 extend with the same length. Furthermore, the reinforcement devices 400 disposed in the region of the first and second separation interface portion A1, A2 extend by way of the first or second length of the respective separation interface portion A1, A2.

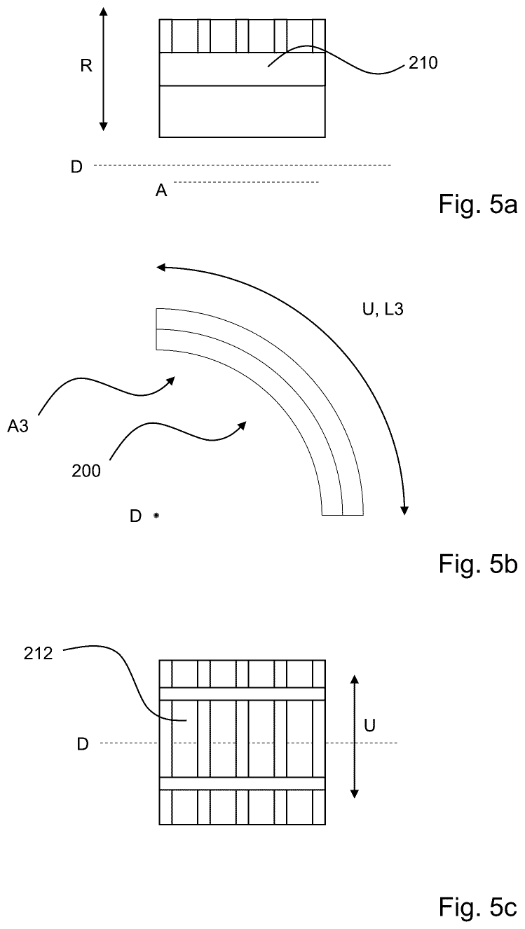

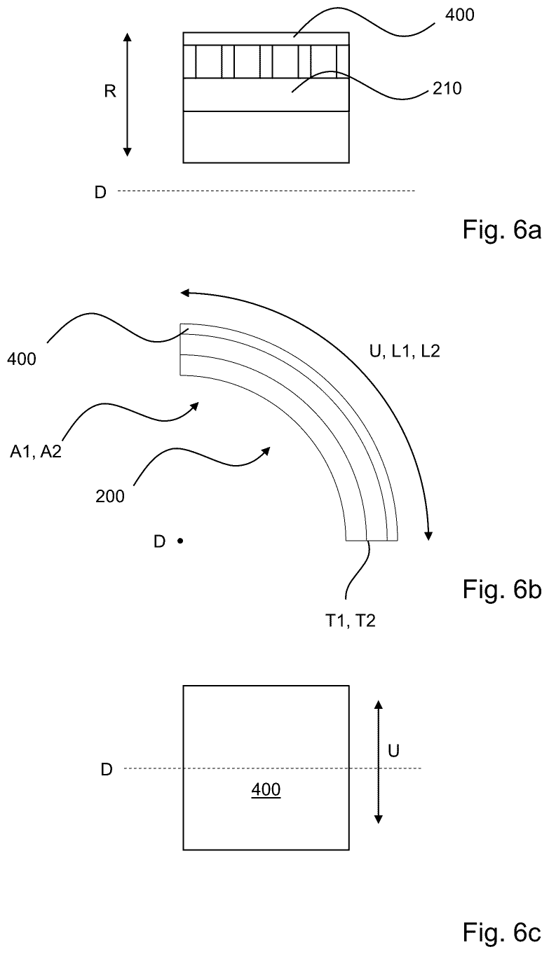

A schematic two-dimensional frontal, lateral and plan view from above of the connection portion of the generator segments 10 illustrated in FIG. 3 is shown in FIGS. 5a, 5b, and 5c. A schematic two-dimensional frontal, lateral and plan view from above of the first and second separation interface portion A1, A2 of the generator segments 10 illustrated in FIG. 3 is shown in FIGS. 6a, 6b, and 6c.

Circumferential webs which extend in the circumferential direction U, and axial webs which extend in the axial direction A along the rotation axis D, are disposed on the rotor external circumferential face 212 of the magnet carrier segment 210. These are disposed both in the region of the connection portion A3 and in the region of the first and second separation interface portion A1, A2. This can be derived, for example, from the two generator segments 10 shown in FIG. 3. Corresponding axial webs and circumferential webs are disposed in the region of the connection portion A3, in the upper generator segment 10 in the view of FIG. 3. These are obscured by the reinforcement device 400 in the first separation interface portion A1. In the lower generator segment 10 shown in FIG. 3, the reinforcement device for the second separation interface portion A2 is not shown, so that the arrangement of the axial webs and circumferential webs is shown here. The axial and circumferential webs, which extend uniformly in the circumferential direction between the first and second separation interface T1, T2, are disposed on the rotor circumferential face 212 and on which a reinforcement element which extends in a planar manner is disposed as reinforcement device 400, can also be derived schematically from FIGS. 6a and 6b.

It is to be understood in particular that no reinforcement device 400 in the context of the disclosure can be seen in these axial webs and circumferential webs that are disposed both in the region of the connection portion A3 and in the region of the first and second separation interface portion T1, T2. Rather, the reinforcement device 400 according to the disclosure is to be understood as an additional reinforcement which, in particular locally, strengthens or reinforces the first and/or second separation interface portion A1, A2 in relation to the connection portion A3.

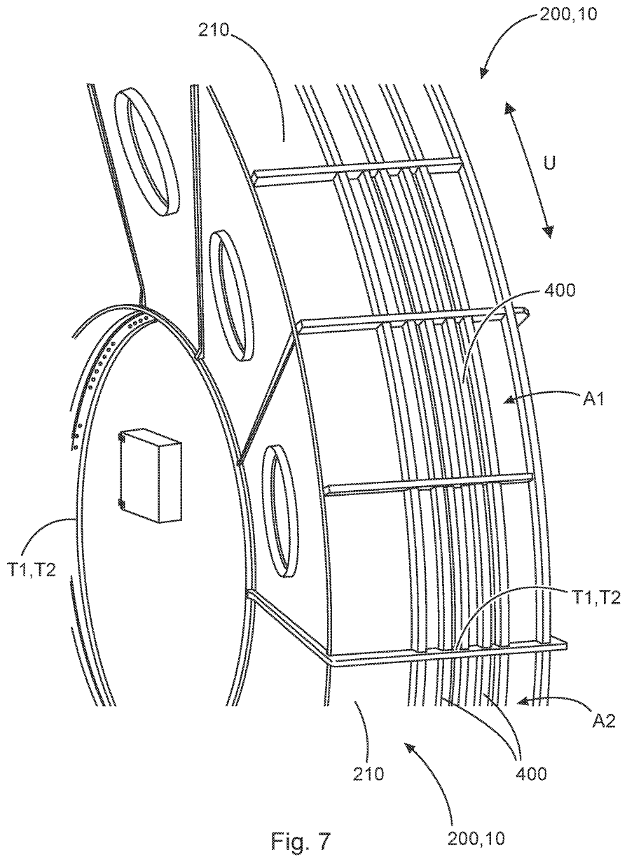

Shown in FIG. 7 is a schematic, three-dimensional view of a further exemplary embodiment of a segmented generator 1, or of two generator segments 10. In this preferred embodiment, it is provided that the two generator segments 10 extend through 180° in the circumferential direction. The two generator segments 10 have a connection device at the first and second separation interfaces T1, T2, via which the two generator segments 10 disposed adjacently in the circumferential direction are connected to one another. Proceeding from the first and second separation interface T1, T2, both generator segments 10 have two circumferential webs as reinforcement device 400 which have a main direction of extent in the circumferential direction U. In the upper generator segment 10 and in portions also in the lower generator segment, it can be clearly seen that the two circumferential webs are disposed between three webs which run in the circumferential direction and extend from the first to the second separation interface on the rotor external circumferential face 212 of the magnet carrier segment 210. This means that both the two separation interface portions A1, A2 and the connection portion A3, which extends between the two separation interface portions A1, A2, have the three webs encircling in the circumferential direction on the rotor external circumferential face 212 of the magnet carrier segment 210. The reinforcement device 400 according to the disclosure cannot be seen in these three webs which extend from the first to the second separation interface T1, T2. Rather, the reinforcement device according to the disclosure can only be seen in the two circumferential webs, which are disposed exclusively in the first and second separation interface portion A1, A2, said reinforcement device reinforcing, in particular locally reinforcing, the first and second separation interface portion A1, A2 of the generator segment 10 in relation to the connection portion A3.

### LIST OF REFERENCE SIGNS

1 Segmented generator
10 Generator segment
100 wind turbine
102 Tower
104 Nacelle
106 Rotor
108 Rotor blades
109 Stator
110 Spinner
200 Rotor segment
210 Magnet carrier
212 Rotor circumferential face
300 Stator segment
400 Reinforcement device
A Axial direction
A1 First separation interface portion
A2 Second separation interface portion
A3 Connection portion
D Rotation axis
L1 First length
L2 Second length
L3 Third length
R Radial direction
T1 First separation interface
T2 Second separation interface
U Circumferential direction

1. A rotor segment of a segmented generator of a wind turbine, comprising:
a magnet carrier segment with a rotor circumferential face, which in a circumferential direction extends between a first and a second separation interface by way of a segment length;
wherein the rotor circumferential face having has:
a first separation interface portion having a first length proceeding from the first separation interface in the circumferential direction toward the second separation interface;
a second separation interface portion having a second length proceeding from the second separation interface in the circumferential direction toward the first separation interface; and
a connection portion having a third length extending between the first and second separation interface; wherein
wherein, in each case a reinforcement device for reinforcing the magnet carrier segment is disposed on the rotor circumferential face in the region of the first and second separation interface portion.

2. The rotor segment as claimed in claim 1, wherein the reinforcement device in the region of the first and/or second separation interface portion locally reinforces the magnet carrier segment in relation to the region of the magnet carrier segment in the connection portion.

3. The rotor segment as claimed in claim 1, wherein the magnet carrier segment with the reinforcement device in the region of the first separation interface portion has a first stiffness, the magnet carrier segment with the reinforcement device in region of the second separation interface portion has a second stiffness, and the connection portion has a third stiffness, wherein:
the third stiffness of the connection portion is less than the first and/or second stiffness of the first and/or second separation interface portion, and/or
the third stiffness of the connection portion corresponds to the first and/or second stiffness of the first and/or second separation interface portion, and/or
the third stiffness of the connection portion is greater than the first and/or second stiffness of the first and/or second separation interface portion.

4. The rotor segment as claimed in claim 1, wherein the first separation interface portion and the second separation interface portion are of substantially identical configuration.

5. The rotor segment as claimed in claim 1, wherein the magnet carrier segment and the reinforcement device in the first and/or second separation interface portion form a cross section with a cross-sectional area and/or a cross-sectional shape that is different from a cross-sectional area and/or a cross-sectional shape of a cross section of the magnet carrier segment in the connection portion.

6. The rotor segment as claimed in claim 1, wherein the reinforcement device is composed of or comprises a material which has a Young's modulus greater than a Young's modulus of a material which the magnet carrier segment comprises or of which the magnet carrier segment is composed.

7. The rotor segment as claimed in claim 1, wherein:
the first and/or second length of the first and/or second separation interface portion corresponds to at least 10%, and at most 50%, of the segment length; and/or
the magnet carrier segment along a rotation axis has a segment width and the reinforcement device has a width which corresponds to at least 30%, and at most 80%, of the segment width.

8. The rotor segment as claimed in claim 1, wherein the reinforcement device has:
a planar reinforcement element;
one or a plurality of axial webs, which have a main extent along the rotation axis;
one or a plurality of circumferential webs, which have a main extent in the circumferential direction orthogonal to the rotation axis; and/or
one or a plurality of diagonal webs, which have a main extent diagonal to the circumferential direction and the rotation axis.

9. The rotor segment as claimed in claim 1, wherein:
a plurality of axial webs are disposed equidistantly from one another in the circumferential direction;
a plurality of circumferential webs are disposed equidistantly from one another in the axial direction; and/or
the planar reinforcement element is disposed spaced parallel to the rotor circumferential face.

10. The rotor segment as claimed in claim 1, wherein the reinforcement device is welded and/or screwed to the rotor circumferential face.

11. The rotor segment as claimed in claim 1, further comprising a reinforcement ring segment, which has a substantial main direction of extent in the circumferential direction and/or a radial direction, for reinforcing the rotor segment.

12. A generator segment of a segmented generator for a wind turbine, comprising a rotor segment as claimed in claim 1.

13. The generator segment as claimed in claim 12, comprising a stator segment.

14. A segmented generator for a wind turbine, comprising two or a plurality of generator segments as claimed in claim 12, wherein the two or plurality of generator segments are disposed in an annular manner.

15. A wind turbine comprising a segmented generator as claimed in claim 14.

16. The rotor segment as claimed in claim 1, wherein the rotor segment is a rotor segment of a permanently excited segmented rotary generator.

17. The rotor segment as claimed in claim 1, wherein the rotor circumferential face is a rotor external circumferential face.

18. The rotor segment as claimed in claim 5, wherein:
the cross-sectional area of the first and/or second separation interface portion is larger than the cross-sectional area of the connection portion; and/or
the cross section of the first and/or second separation interface portion has a moment of inertia of area and/or a torsional moment of inertia which is greater than a moment of inertia of area and/or a torsional moment of inertia of the cross section of the connection portion.

19. The rotor segment as claimed in claim 1, wherein:
the first and/or second length of the first and/or second separation interface portion corresponds to at least 20%, and at most 40%, of the segment length; and/or
the magnet carrier segment along a rotation axis has a segment width and the reinforcement device has a width which corresponds to at least 50%, and at most 100%, of the segment width.
